(19) United States
(12) Patent Application Publication
(10) Pub. No.: US 2024/0383764 A1
(43) Pub. Date: Nov. 21, 2024

(54) PLANT AND PROCESS FOR THE CONTINUOUS PRODUCTION OF AMMONIA USING RENEWABLE ENERGIES

(71) Applicant: UNIPER TECHNOLOGIES GMBH, Gelsenkirchen (DE)

(72) Inventor: Ingo WAGNER, Essen (DE)

(73) Assignee: UNIPER TECHNOLOGIES GMBH, Gelsenkirchen (DE)

(21) Appl. No.: 18/688,316

(22) PCT Filed: Aug. 31, 2022
(86) PCT No.: PCT/EP2022/074228

§ 371 Date: Feb. 29, 2024

(30) Foreign Application Priority Data
Sep. 1, 2021 (DE) 10 2021 122 602.3

(51) Int. Cl. C01C 1/04; C01B 3/04; C25B 1/04

(52) U.S. Cl. CPC C01C 1/0488; C01B 3/047; C25B 1/04; C01B 2203/0277; C01B 2203/068; C01B 2203/0838; C01B 2203/1657

(57) ABSTRACT

The present invention relates to a plant and a process for the continuous production of ammonia using renewable energies. The system includes at least one cracking unit for the catalytic cracking of ammonia. The process provides that part of the ammonia produced is catalytically cracked again, namely when availability decreases and/or when the amount of renewable energy falls below a minimum amount or when the supply of gaseous hydrogen falls below a minimum amount.

The present invention relates to a plant and a process for the continuous production of ammonia using renewable energies. The system includes at least one cracking unit for the catalytic cracking of ammonia. The process provides that part of the ammonia produced is catalytically cracked again, namely when availability decreases and/or when the amount of renewable energy falls below a minimum amount or when the supply of gaseous hydrogen falls below a minimum amount.

### TECHNICAL BACKGROUND AND PRIOR ART

Ammonia is one of the basic chemicals. It is produced using the Haber-Bosch process through the catalytic conversion of so-called synthesis gas. In the context of ammonia synthesis, synthesis gas refers to a mixture of hydrogen and nitrogen in a quantitative ratio of approximately 3:1.

Global ammonia production is hundreds of millions of tons per year. The largest proportion of ammonia currently goes into a traditional field of application, namely fertilizer production. However, it is to be expected that new markets for ammonia will emerge in the future, which will significantly increase the demand for ammonia and push its use in the fertilizer sector into the background. Because ammonia is becoming increasingly important as an energy source and hydrogen storage form. It has a high energy density and can be stored comparatively easily in tanks. In addition, in contrast to hydrogen, it liquefies at ambient pressure at minus 33° C. or at ambient temperature at approx. 8.5 bar pressure, which makes transport easier. There are also concepts for using ammonia as a fuel in shipping traffic. Of course, the use of ammonia as an energy source and hydrogen storage form only makes ecological sense if ammonia is produced sustainably.

The classic, unsustainable ammonia synthesis process uses hydrogen that is obtained from a fossil raw material (e.g. natural gas). Despite the increasing shortage of fossil raw materials, hydrogen can be produced in this way as needed and made available in sufficient quantities for ammonia synthesis. Uniform utilization of the ammonia synthesis plant is guaranteed. In particular, if hydrogen is produced on demand, it is possible to avoid the ammonia synthesis plant ending up in inefficient or unstable operating states or even having to be switched off completely. An unstable operating condition occurs in most ammonia synthesis plants when the throughput is less than 50% to 60% of the design capacity.

However, achieving consistent utilization of the ammonia synthesis plant in the production of green ammonia represents a challenge. When producing green ammonia, the hydrogen required for ammonia synthesis is produced using electrolysis, with the electrical energy required for electrolysis coming from renewable sources (e.g. solar energy, wind power or hydropower). The electrical energy available from renewable sources is subject to natural fluctuations. This leads to a lack of electrical energy supply to the electrolysis system and, as a result, to fluctuating amounts of hydrogen produced. In the worst case scenario, hydrogen can no longer be supplied to the ammonia system. If the available amount of hydrogen is below the minimum demand of the ammonia plant required for stable operation, the ammonia synthesis plant must be shut down and switched off. Frequent slowdowns, shutdowns and subsequent restarts of the ammonia system are generally undesirable. It leads to accelerated wear on system components and lower overall system effectiveness.

In order to prevent an undesirable shutdown of the ammonia system, even when producing sustainably generated, ie green, ammonia, a storage facility for hydrogen or synthesis gas is usually provided. However, this involves considerable capital costs. In addition, there are high costs for storing hydrogen (low energy content per unit volume and high pressure or low temperatures for liquefaction). In addition, the planning or design of such a storage system is also complicated by the fact that the availability of renewable energies is difficult to predict. On the one hand, it depends on the type of energy source and, on the other hand, it is subject to periods of different and unknown durations.

Furthermore, ammonia synthesis plants are being designed that can still be operated stably at lower throughputs than the usual 50% to 60% of the design capacity. Such an approach is known, for example, from EP 2 589 574 A1. Here, a reduced supply of synthesis gas is compensated for by a corresponding supply of inert gases, such as argon or helium. This means that the minimum throughput at which stable operation of the ammonia synthesis plant is still possible can be reduced to 10-20% of the design capacity.

### OBJECT OF THE INVENTION

Against this background, the object of the present invention was to develop an improved system for producing ammonia, with which continuous production is possible using exclusively renewable energies and with which the disadvantages of conventional systems described above can be overcome. Furthermore, a process is to be specified that allows continuous ammonia production using only renewable energy and that is robust and cost-effective compared to conventional processes.

### SUMMARY OF THE INVENTION

These problems are solved by the subject matter according to the independent claims. Further advantageous embodiments can be derived from the dependent claims.

The plant according to the invention is a plant for the continuous production of ammonia using renewable energies, comprising an electrolyzer for the electrolytic splitting of water into gaseous hydrogen and oxygen using renewable energies; a unit for providing gaseous nitrogen; a mixer for producing a synthesis gas from the gaseous hydrogen and the gaseous nitrogen; an ammonia synthesis unit for reacting the synthesis gas to obtain ammonia; and at least one cracking unit for catalytically cracking the ammonia obtained in the ammonia synthesis unit, whereby synthesis gas is again obtained.

A conventional unit is used as the ammonia synthesis unit, for example a unit that is suitable for synthesizing ammonia using the classic Haber-Bosch process.

The term renewable energies includes renewable energies that are not based on nuclear power or non-fossil energy sources. Examples of renewable energies are solar, wind, water, bioenergy or geothermal energy.

The system according to the invention therefore allows environmentally friendly and sustainable production of ammonia. It is not necessarily dependent on expensive hydrogen storage and is still able to respond to fluctuations in the availability of renewable energy. Switching off the ammonia synthesis unit when the volume flow of hydrogen from the electrolyzer decreases can be effectively avoided.

The cracking unit (the cracking reactor) preferably has a capacity that corresponds at least to the minimum throughput of the ammonia synthesis unit. Ideally, the cracking unit has a capacity that is greater than 10% of the design capacity of the ammonia synthesis unit. The capacity of the cracking unit is particularly preferably 10%-30% of the design capacity of the ammonia synthesis unit. This dimensioning ensures that the ammonia synthesis unit does not have to be switched off even in the event of a complete drop-out of renewable energy and can continue to operate in a stable operating state.

At least one connection is preferably present between the ammonia synthesis unit and the at least one cracking unit.

The at least one connection may be a connection between the outlet of the ammonia synthesis unit and the inlet of the cracking unit. This connection can include at least one valve element that is designed to separate or allow fluidic communication between the at least one cracking unit and the ammonia synthesis unit.

In a further preferred embodiment, the system comprises a control unit which is set up to throttle or increase the throughput of the cracking unit depending on the availability of renewable energy and/or the available amount of gaseous hydrogen. The throughput of the cracking unit can be controlled, for example, by regulating the above-mentioned valve element included in the connection between the ammonia synthesis unit and the cracking unit. The availability of renewable energies, on the basis of which the throughput can be controlled, includes the current availability of renewable energies (verifiable through measurement or request from the network operator). If desired, the availability of renewable energies also includes an expected value for the development of availability in the near future. The expected value can be calculated based on current data (e.g. weather conditions) and empirical equations. In particular, it is preferred to increase the throughput of the cracking unit when the availability of renewable energy decreases. Conversely, consideration should be given to reducing the throughput of the cracking unit again when renewable energies are readily available again after a temporary shortage. The system can therefore serve as an energy storage means in times of overproduction of renewable energies and allows stable operation in times with low availability of renewable energies.

The connection between the outlet of the ammonia synthesis unit and the inlet of the at least one cracking unit can be designed as a direct connection, so that the ammonia obtained can be introduced into the cracking unit of the system without prior intermediate storage. In this case, the connection is a pipe or conduit, which may be provided with various fittings and measuring instruments and may include one or more heat exchangers, but does not include a storage tank, a buffer tank or other plant units. Alternatively, the connection between the outlet of the ammonia synthesis unit and the inlet of the at least one cracking unit can comprise a container for storing ammonia and optionally further units.

The advantage of a direct connection is that the heat losses when transferring the ammonia from the ammonia synthesis unit to the cracking unit are low. This makes it possible to cut down on some of the energy required to initiate endothermic ammonia splitting. If green hydrogen is not available, the ammonia synthesis unit and the cracking unit are coupled to one another and are operated in a cycle without the need to operate additional system units, such as heat exchangers, compressors and separators.

The advantage of a connection that includes a container for storing ammonia is that the operation of the cracking unit is largely decoupled from the operation of the ammonia synthesis unit. The throughput of the cracking unit can be regulated independently of the throughput of the ammonia synthesis unit. This represents an additional degree of freedom and improves the ability to initiate and maintain stable operation of the system. If additional units are interposed between the outlet of the ammonia synthesis unit and the inlet of the at least one cracking unit, such as one or more condensers, separators, scrubbers, heat exchangers, compressors and pumps, these units also remain in operation, even if there is insufficient renewable energy and/or in the short term, sufficient amounts of green hydrogen available for ammonia synthesis.

In one embodiment, the system according to the invention can comprise a connection between the outlet of the cracking unit and the inlet of the ammonia synthesis unit. This connection can be designed as a direct connection. In this case, the connection is a pipe or a line, which can be provided with various fittings and measuring instruments and optionally contains one or more heat exchangers, but no synthesis gas storage for the temporary storage of synthesis gas. In this way, the synthesis gas obtained by cracking can be passed directly into the ammonia synthesis unit without prior intermediate storage. Alternatively, the connection between the outlet of the cracking unit and the inlet of the ammonia synthesis unit can comprise at least one synthesis gas storage for the temporary storage of synthesis gas. The synthesis gas storage preferably has a small volume and serves to compensate for short-term fluctuations in the supply of synthesis gas through renewable energies, which overall contributes to a uniform operation of the ammonia synthesis plant.

In addition, the system according to the invention can comprise at least one heat exchanger. This is advantageous because the ammonia synthesis is exothermic and the cleavage reaction of ammonia to hydrogen and nitrogen is endothermic and heat integration in the system can be achieved with the help of one or more heat exchangers. Part of the energy supply required to cleave the ammonia can be recovered from the ammonia synthesis unit. The additional energy required to operate the cracking unit is provided as electrical energy or by combustion of a material stream containing ammonia or hydrogen from the system.

Among the preferred embodiments, the embodiment of the plant for the continuous production of ammonia using renewable energy is particularly advantageous, comprising the following:
(i) an electrolyzer for electrolytically splitting water into gaseous hydrogen and oxygen using renewable energies;
(ii) a unit for providing gaseous nitrogen;
(iii) a mixer for producing a synthesis gas from the gaseous hydrogen and the gaseous nitrogen;
(iv) an ammonia synthesis unit for reacting the synthesis gas to obtain ammonia;
(v) at least one cracking unit for catalytically cracking the ammonia obtained in (iv), whereby synthesis gas is again obtained; and
(vi) a connection between the outlet of the at least one cracking unit and the inlet of the ammonia synthesis unit.

In addition, a process for the continuous production of ammonia using renewable energies is specified, in which gaseous hydrogen is obtained from water using renewable energies (i), gaseous nitrogen is provided (ii); the gaseous hydrogen and the gaseous nitrogen are mixed (iii) to obtain a synthesis gas; and the synthesis gas is converted in an ammonia synthesis unit (iv) in order to obtain ammonia, the method being characterized in that when availability of renewable energy decreases and/or when the amount falls below a minimum amount and/or when the amount of gaseous hydrogen falls below a minimum amount, in step (i) at least part of the ammonia obtained is catalytically cracked again (v) in order to provide synthesis gas for step (iv).

The catalytic cleavage of ammonia is preferably carried out at a temperature of at least 300° C., preferably in a temperature range of 400 to 900° C.

At least part of the thermal energy generated during the conversion of the synthesis gas in step (iv) is advantageously used to preheat the portion of ammonia intended for cracking.

### DESCRIPTION OF THE PREFERRED EMBODIMENTS

Preferred embodiments of the invention are explained in more detail with reference to the following figures and experiments, without intending to restrict the invention thereto.

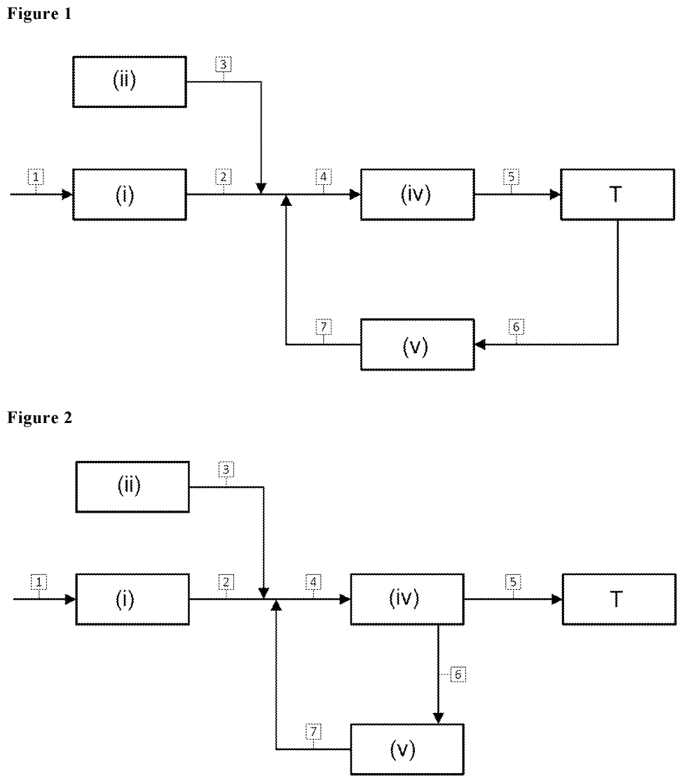

FIG. 1 shows a greatly simplified flow diagram of the method of the invention according to a first embodiment variant. The plant according to the invention in which this method can be carried out has a connection between the outlet of the ammonia synthesis plant and the inlet of the at least one cracking unit, which comprises an ammonia storage tank.

FIG. 2 shows a greatly simplified flow diagram of the method of the invention according to a second embodiment variant. The plant according to the invention in which this method can be carried out has a connection between the outlet of the ammonia synthesis plant and the inlet of the at least one cracking unit.

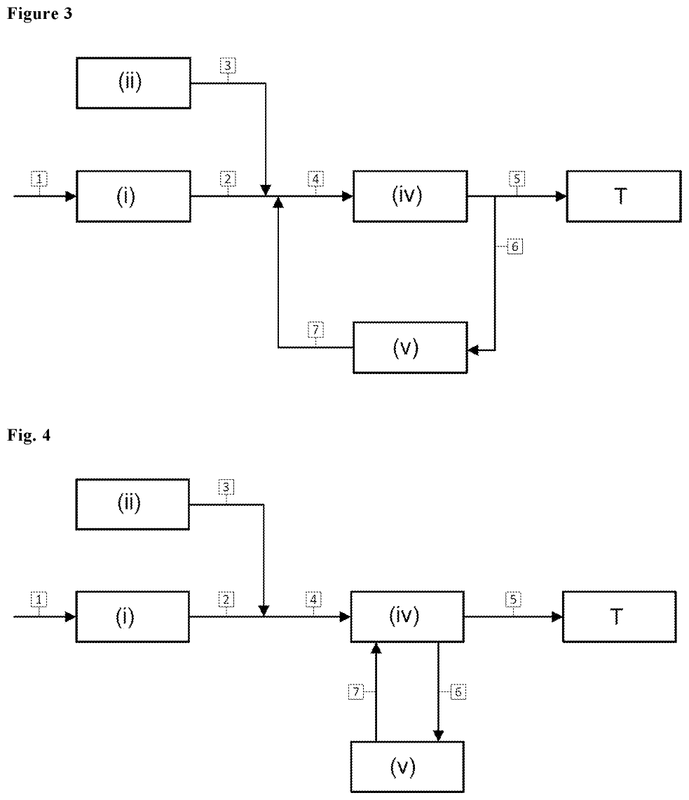

FIG. 3 shows a flow diagram of the method according to the invention, in which the circuit between the ammonia synthesis system and the cracking unit, which has a direct connection between the outlet of the ammonia synthesis plant and the inlet of the at least one cracking unit, is shown differently than in FIG. 2.

FIG. 4 shows a flow diagram of the method according to the invention, in which the circuit between the ammonia synthesis system and the cracking unit, which has a direct connection between the outlet of the ammonia synthesis plant and the inlet of the at least one cracking unit, is shown differently than in FIGS. 2 and 3.

In FIG. 1, (i) denotes the electrolyzer for the electrolytic splitting of water, which is operated exclusively with electricity from renewable energies. Stream 1 is the water stream that is fed to the electrolyzer. Product stream 2 is gaseous hydrogen (also called green hydrogen). Unit (ii) is, for example, an air separation unit with which a stream 3 of gaseous nitrogen can be provided. The gaseous hydrogen stream and the gaseous nitrogen stream are mixed in a ratio of 3:1 (mixer not shown, but present where streams 2 and 3 join), so that a synthesis gas 4 is formed. The synthesis gas is fed to the ammonia synthesis unit (iv) and converted into ammonia there. Various further steps for purification and heat exchange can then follow (corresponding units not shown) before the ammonia stream 5 is fed into a storage tank T. The cracking unit (v), when in operation, draws ammonia as stream 6 from the storage tank. The synthesis gas obtained after cracking of ammonia is returned to the ammonia synthesis unit (iv) (compound 7). The ammonia synthesis unit can be operated in circulation using the cracking unit and compounds 6 and 7, even if green hydrogen is not available. Since the storage tank T serves as a buffer volume, it is not absolutely necessary to adapt the throughput of the cracking unit (v) to the throughput of the ammonia synthesis unit (iv).

The flow diagram in FIG. 2 uses the same units and reference numbers as FIG. 1. In contrast to FIG. 1, however, there is a direct connection between the outlet of the ammonia synthesis unit (iv) and the inlet of the cracking unit (v) without an intermediate storage container or other intermediate units. During operation of the cracking unit, ammonia is diverted from the ammonia synthesis unit (iv) and fed into the cracking unit (v) as stream 6. The recycling of synthesis gas into the ammonia synthesis unit (iv) takes place as stream 7.

As can be seen in FIGS. 3 and 4, the diversion of the ammonia stream from the ammonia synthesis unit (iv) and the return of the synthesis gas can also be designed differently than in FIG. 2. In this context, FIG. 3 illustrates the diversion of the ammonia stream after the ammonia synthesis unit (iv). In FIG. 4, the arrows, which indicate the diversion of the ammonia stream and the return of the synthesis gas, are directly attached to the ammonia synthesis unit (iv). Returning the synthesis gas directly to the ammonia synthesis unit (iv) is also conceivable in the embodiment variant in FIG. 1.

1. A plant for the continuous production of ammonia using renewable energies comprising:
(i) an electrolyzer for electrolytically splitting water into gaseous hydrogen and oxygen using renewable energies;
(ii) a unit for providing gaseous nitrogen;
(iii) a mixer for producing a synthesis gas from the gaseous hydrogen and the gaseous nitrogen;
(iv) an ammonia synthesis unit for reacting the synthesis gas to obtain ammonia; and
(v) at least one cracking unit for catalytically cracking the ammonia obtained in (iv), whereby synthesis gas is again obtained.

2. The plant according to claim 1, wherein there is a connection between an outlet of the ammonia synthesis unit and an inlet of the at least one cracking unit, the connection comprising at least one valve element which is able to separate or allow fluidic communication between the at least one cracking unit and the ammonia synthesis unit.

3. The plant according to claim 2, wherein the connection between the outlet of the ammonia synthesis unit and the inlet of the at least one cracking unit is either direct or comprises at least one further unit which is interposed.

4. The plant according to claim 1, further comprising a control unit which is set up to throttle or increase throughput of the cracking unit depending on the availability of renewable energies and/or available amount of gaseous hydrogen.

5. The plant according to claim 1, further comprising at least one synthesis gas storage for the temporary storage of synthesis gas.

6. The plant according to claim 1 further comprising at least one heat exchanger.

7. A process for the continuous production of ammonia using renewable energy, in which
(i) gaseous hydrogen is obtained from water using renewable energies,
(ii) gaseous nitrogen is provided;
(iii) the gaseous hydrogen and the gaseous nitrogen are mixed to obtain a synthesis gas; and
(iv) the synthesis gas is reacted in an ammonia synthesis unit to obtain ammonia,
wherein when availability decreases and/or when the amount of renewable energy falls below a minimum amount, and/or when the amount of gaseous hydrogen falls below a minimum amount, in step (i), at least part of the ammonia obtained is catalytically cracked again (v) in order to provide synthesis gas for step (iv).

8. The process according to claim 7, wherein the catalytic cracking of ammonia is carried out at a temperature of at least 300° C.

9. The method according to claim 7, wherein at least part of the thermal energy generated during the conversion of the synthesis gas in step (iv) is used to preheat the portion of ammonia intended for the cracking.

10. The process according to claim 7, wherein the catalytic cracking of ammonia is carried out at a temperature of from 400 to 900° C.

11. The plant according to claim 3, wherein the at least one further unit is a container for storing ammonia.
